(19) United States
(12) Patent Application Publication
(10) Pub. No.: US 2006/0047994 A1
(43) Pub. Date: Mar. 2, 2006

(54) Method for burning BIOS

(75) Inventors: Ke Pu, Shenzhen (CN); Chun-Yang Wu, Shenzhen (CN)

Correspondence Address: MORRIS MANNING & MARTIN LLP, 1600 ATLANTA FINANCIAL CENTER, 3343 PEACHTREE ROAD, NE, ATLANTA, GA, 30326-1044, US

(73) Assignee: HON HAI Precision Industry CO., LTD., Tu-Cheng City (TW)

(21) Appl. No.: 11/199,676

(22) Filed: Aug. 8, 2005

(30) Foreign Application Priority Data
Aug. 26, 2004 (CN) 200410051280.5

(51) Int. Cl. G06F 11/00

(52) U.S. Cl. 714/2

(57) ABSTRACT

A method for burning BIOS comprises the steps of: (1) providing a corrupted motherboard with a corrupted BIOS attached; (2) providing a burning device for receiving the corrupted motherboard; (3) providing a BIOS burning card for receiving a burning instruction from the burning device to start burning; (4) the BIOS burning card detecting the corrupted BIOS whether the corrupted BIOS is blank, if the corrupted BIOS being not blank, erasing the corrupted BIOS; (5) the BIOS burning card sending information to the corrupted BIOS to burn the corrupted BIOS; and (6) verifying the corrupted BIOS.

### BACKGROUND OF THE INVENTION

1. Field of the Invention

The present invention relates to a method for burning BIOS (Basic Input Output System), and more particularly to a method for burning BIOS online.

2. Background of the Invention

It is well known that BIOS is very important for the computer system. When the computer system is powered up or reset, the BIOS program runs to initialize the computer and permit the startup of an operating system, such as Microsoft Windows XP. The BIOS program typically resides in a nonvolatile memory such as a read-only memory (ROM), an electrically programmable read only memory (EPROM), electrically erasable programmable nonvolatile memory (EEPROM) and flash memory device (e.g., flash EEPROM). The BIOS program can reside in these memories even if the power is cut off.

Conventionally, BIOS is burned in a chip before the BIOS chip is attached to a motherboard. A chip-burning device includes a buffer, a micro processing unit, a burning unit and a communication circuit. After BIOS is burned by the device, the BIOS chip is attached to a motherboard. But pins of the BIOS chip are easily damaged in the attaching course. And this method of burning BIOS is time-consuming, and inefficient especially in mass-produced course.

What is needed, therefore, is a high efficiency method for burning BIOS which also protects the BIOS chip from being damaged.

### SUMMARY

A method for burning BIOS comprises the steps of: (1) providing a corrupted motherboard with a corrupted BIOS attached; (2) providing a burning device for receiving the corrupted motherboard; (3) providing a BIOS burning card for receiving a burning instruction from the burning device to start burning; (4) the BIOS burning card detecting the corrupted BIOS whether the corrupted BIOS is blank, if the corrupted BIOS being not blank, erasing the corrupted BIOS; (5) the BIOS burning card sending information to the corrupted BIOS to burn the corrupted BIOS; and (6) verifying the corrupted BIOS.

Advantages and novel features of the present invention will be drawn from the following detailed description of a preferred embodiment of the present invention with attached drawings, in which:

### BRIEF DESCRIPTION OF THE DRAWINGS

FIG. 1 is a block diagram of a system for burning BIOS in accordance with a preferred embodiment of the present invention;

FIG. 2 is a flow diagram showing the operation principle of the system of FIG. 1;

FIG. 3 is a flow diagram showing the main process for burning a corrupted BIOS;

FIG. 4 is a flow diagram showing details of an erasing process of FIG. 3; and

FIG. 5 is a flow diagram showing details of a burning process of FIG. 3.

### DETAILED DESCRIPTION OF PREFERRED EMBODIMENT

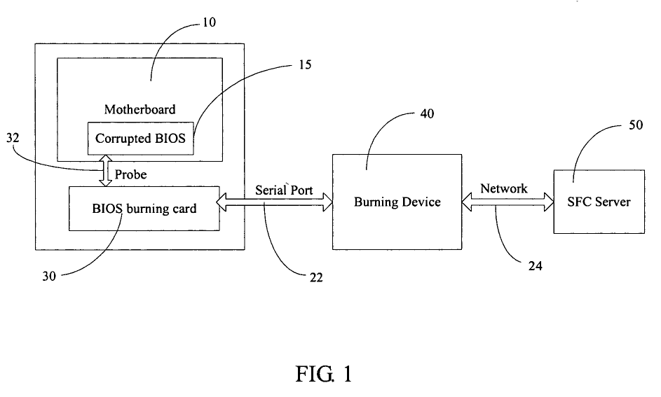

Referring to FIG. 1, a BIOS burning system for implementing a BIOS burning method to program a Basic Input Output System (BIOS) in according with a preferred embodiment of the present invention includes a BIOS burning card 30 controlled by a single-chip microcomputer, a burning device 40 and a soft control (SFC) server 50.

The burning device 40 has a burning workbench for positioning a corrupted motherboard 10 with a corrupted BIOS 15 attached thereon. The BIOS program 15 typically resides in a nonvolatile programmable memory chip such as a read-only memory (ROM), an electrically programmable read only memory (EPROM), electrically erasable programmable nonvolatile memory (EEPROM) and flash memory device (e.g., flash EEPROM).

The BIOS burning card 30 is connected with the corrupted motherboard 10 by several probes 32 with which data signal, address signal, control signal and power are transferred from the BIOS burning card 30 to the corrupted motherboard 10. The BIOS burning card 30 has a mother BIOS for providing the information sent to the corrupted BIOS 15.

The burning device 40 is a personal computer. The burning device 40 is provided for man-machine conversation and yield statistics. The burning device 40 and the BIOS burning card 30 are connected with each other by serial ports 22. The burning device 40 sets burning parameters, and sends the burning parameters to the BIOS burning card 30. The burning device 40 also verifies the mother BIOS of the BIOS burning card 30.

The burning device 40 is connected with the SFC server 50 through network 24. The burning device 40 scans a barcode of the corrupted BIOS and sends it to the SFC server 50. The burning device 40 also sends a burning result to the SFC server 50. The SFC server 50 records the barcode and the result.

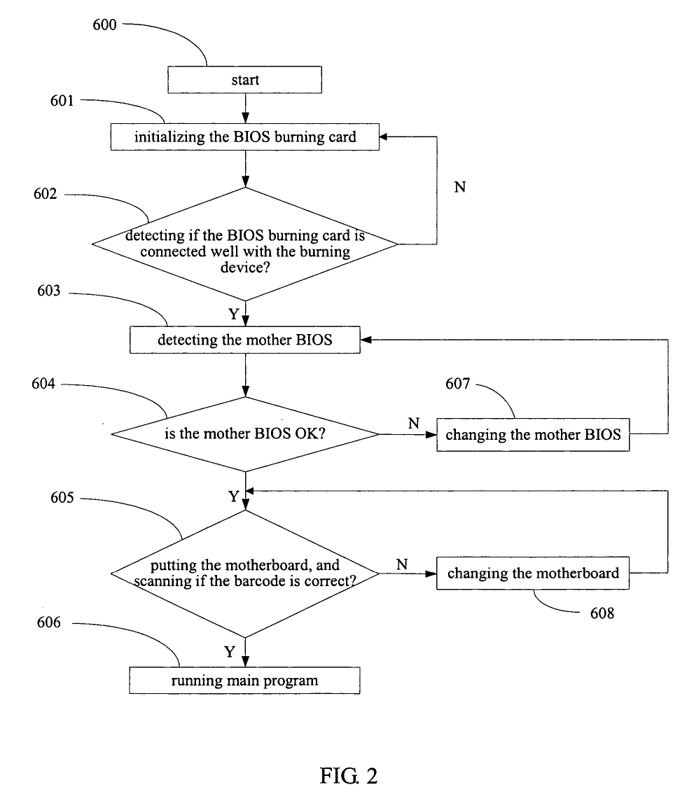

Referring to FIG. 2, the main process starts from step 600. The single-chip microcomputer is initialed (step 601). The single-chip microcomputer detects whether the BIOS burning card 30 is connected well with the burning device 40 (step 602). If the BIOS burning card 30 is not connected well with the burning device 40 (i.e., the “N” branch from step 602), the step 601 is repeated until the step 602 is confirmed. If the BIOS burning card 30 is connected well with the burning device 40 (i.e., the “Y” branch from step 602), the burning device 40 detects whether the mother BIOS of the BIOS burning card 30 is correct (step 603). If the mother BIOS is not correct (i.e., the “N” branch from step 604), the mother BIOS is changed (step 607) and then the changed BIOS is detected (step 603).

Returning to step 604, if the mother BIOS is correct (i.e., the “Y” branch from the step 604), the corrupted motherboard 10 is putted onto the burning workbench of the burning device 40 (step 605). A barcode of the corrupted motherboard 10 is scanned (step 605). If the barcode is not correct (i.e., the “N” branch from the step 605), change the corrupted motherboard (step 608). The process goes to step 605.

If the barcode is correct, a main program starts to run (step 606).

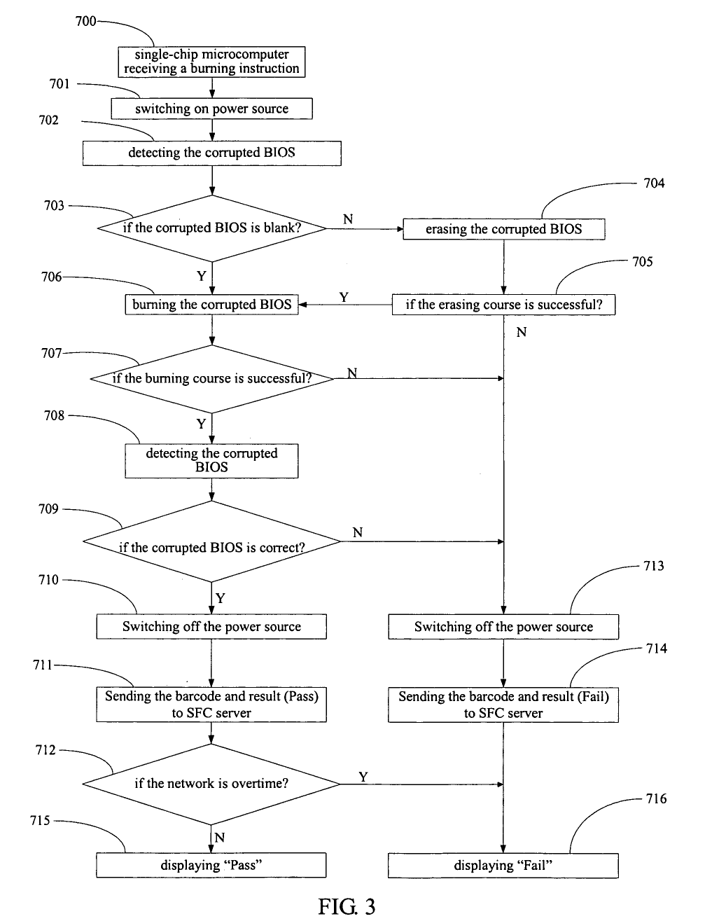

Referring to FIG. 3, the flow chart of running the main program is showed. The main program starts from step 700. At step 700, the single-chip microcomputer receives a burning instruction. The burning device 40 switches on a power source for burning (step 701). The corrupted BIOS 15 is detected (step 702) to decide whether the corrupted BIOS 15 is blank (step 703).

If the corrupted BIOS 15 is blank (i.e., the “Y” branch from step 703), the corrupted BIOS 15 is burned (step 706).

If the corrupted BIOS 15 is not blank (i.e., the “N” branch from step 703), the corrupted BIOS 15 is erased (step 704). The corrupted BIOS 15 is detected whether the erasing course is successful (step 705). If the erasing course is successful, the process goes to step 706.

If the erasing course is not successful, the burning device 40 switches off the power source (step 713). The barcode of the corrupted motherboard 10 and a result (Fail) are sent to the SFC server (step 714). The result (Fail) is displayed to the operator (step 716).

Returning to step 706, the corrupted BIOS 15 is burned. The burning course is detected whether the burning course is successful (step 707). If the burning course is not successful (i.e., the “N” branch from step 707), the burning device 40 switches off the power source (step 713). The barcode of the corrupted motherboard 10 and a result (Fail) are sent to the SFC server (step 714). The result (Fail) is displayed to the operator (step 716).

If the burning course is successful (i.e., the “Y” branch from step 707), the corrupted BIOS 15 is detected (step 708) whether the corrupted BIOS 15 is correct (step 709). If the corrupted BIOS 15 is not correct (i.e., the “N” branch from step 709), the burning device 40 switches off the power source (step 713). The barcode of the corrupted motherboard 10 and a result (Fail) are sent to the SFC server (step 714). The result (Fail) is displayed to the operator (step 716).

If the corrupted BIOS 15 is correct (i.e., the “Y” branch from the step 709), the burning device 40 switches off the power source (step 710). The barcode of the corrupted motherboard 10 and a result (Pass) are sent to the SFC server (step 711). The network 24 between the burning device 40 and the SFC server 50 is checked whether it is overtime. If the network 24 is overtime (i.e., the “Y” branch from step 712), The result (Fail) is then displayed to the operator (step 716). If the network 24 is not overtime (i.e., the “N” branch from step 712), The result (Pass) is displayed to the operator (step 715).

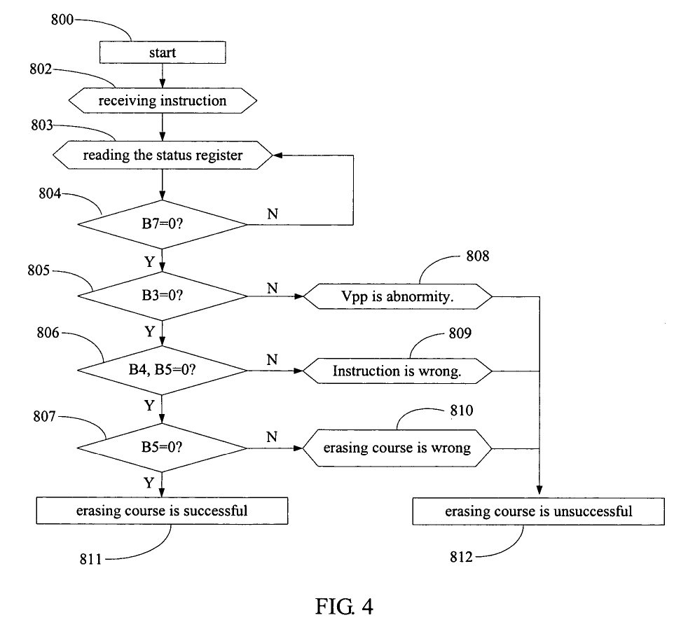

Referring to FIG. 4, details of the erasing course in the step 704 of the FIG. 3 are showed. The erasing course starts from step 800. The single-chip microcomputer receives instructions from the burning device 40 to erase the corrupted BIOS 15 (step 802). A status register of the single-chip microcomputer is read (step 803). The recording content of a “B7” bit of the status register is checked whether the B7 bit is equal to 0 (step 804). If the B7 bit is not equal to 0, it indicates that the erasing process is not completed. Then the process goes back to step 803 (i.e., the “N” branch from the step 804) until the erasing process is completed.

If the B7 bit is equal to 0, it indicates that the erasing course is completed. The content of a “B3” bit of the status register is then detected whether the B3 bit is equal to 0 (step 805). If the B3 bit is not equal to 0, it indicates that the burning voltage (Vpp) is abnormity (step 808) and the erasing course is unsuccessful (step 812).

If the B3 bit is equal to 0, the content of a “B4” bit and “B5” bit of the status register are checked whether the B4 bit and the B5 bit are equal to 0 (step 806). If the B4 bit and the B5 bit are not equal to 0, it indicates that the corrupted BIOS 15 receives wrong instruction (step 809) and the erasing course is unsuccessful (step 812).

If the B4 bit and the B5 bit are equal to 0, the content of the B5 bit is checked whether the B5 bit is equal to 0 (step 807). If the B5 bit is not equal to 0, it indicates that the erasing course is wrong (step 810) and the erasing course is unsuccessful (step 812).

If the B5 bit is equal to 0, the erasing course is successful (step 811).

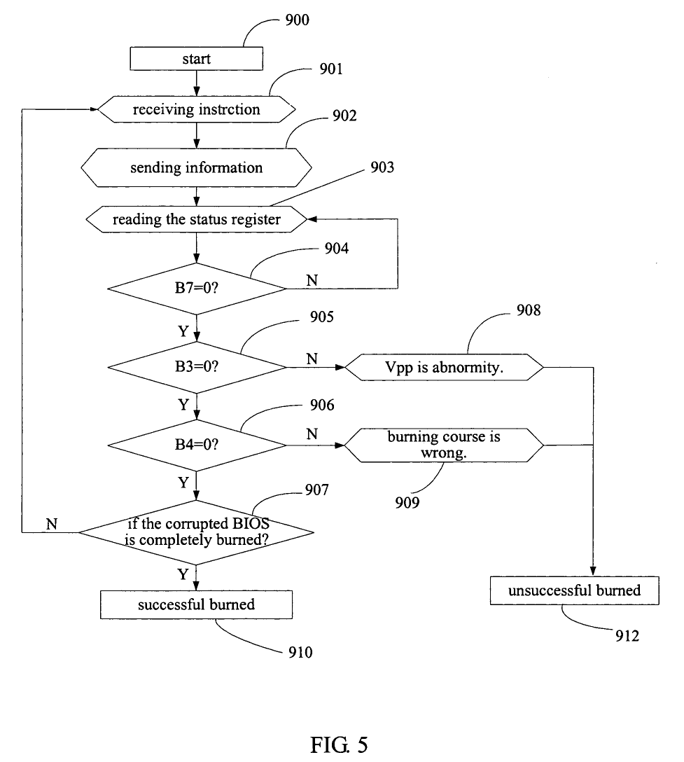

Referring to FIG. 5, details of the burning course in step 706 of the FIG. 3 are showed. The burning course starts from step 900. The single-chip microcomputer receives instructions from the burning device 40 to burn the corrupted BIOS 15 (step 901). The single-chip microcomputer reads information from the mother BIOS, and then sends the information to the corrupted BIOS 15 (step 902). A status register of the single-chip microcomputer is read (step 903). The recording content of a “B7” bit of the status register is checked whether the B7 bit is equal to 0 (step 904). If the B7 bit is not equal to 0, it indicates that the burning process is not completed. Then the process goes back to step 903 (i.e., the “N” branch from the step 904) until the burning process is completed. If the B7 bit is equal to 0, it indicates that the burning course is completed. The content of a “B3” bit of the status register is then detected whether the B3 bit is equal to 0 (step 905). If the B3 bit is not equal to 0, it indicates that the burning voltage (Vpp) is abnormity (step 908) and the burning course is unsuccessful (step 912).

If the B3 bit is equal to 0, the content of a “B4” bit of the status register is checked whether the B4 bit is equal to 0 (step 906). If the B4 bit is not equal to 0, it indicates that the burning course is wrong (step 909) and the burning course is unsuccessful (step 912).

If the B4 bit is equal to 0, the corrupted BIOS 15 is checked if the corrupted BIOS 15 is completely burned (step 907). If the corrupted BIOS 15 is not completely burned, the process goes back to step 901. If the corrupted BIOS 15 is completely burned, the burning course is successful (step 910).

It is to be understood, however, that even though numerous characteristics and advantages have been set forth in the foregoing description of the preferred embodiments, together with details of the structure and function the disclosure is illustrative only, and changes may be made in detail, especially in matters of shape, size, equivalent materials, and arrangement of parts within the principles of the invention to the full extent indicated by the broad general meaning of the terms in which the appended claims are expressed.

We claim:

1. A method for burning BIOS comprising the steps of:
providing a corrupted motherboard with a corrupted BIOS attached;
providing a burning device for receiving the corrupted motherboard;
providing a BIOS burning card for receiving a burning instruction from the burning device to start burning;
the BIOS burning card detecting the corrupted BIOS whether the corrupted BIOS is blank, if the corrupted BIOS being not blank, erasing the corrupted BIOS;
the BIOS burning card sending information to the corrupted BIOS to burn the corrupted BIOS; and
verifying the corrupted BIOS.

2. The method as described in claim 1, wherein the BIOS burning card has a single-chip microcomputer.

3. The method as described in claim 2, wherein erasing the corrupted BIOS comprises the following steps:
the single-chip microcomputer receiving instructions; and
checking B7, B3, B4, B5 bits of the single-chip microcomputer's status register.

4. The method as described in claim 2, wherein burning the corrupted BIOS comprises the following steps:
the single-chip microcomputer receiving instructions;
the single-chip microcomputer sending information;
checking B7, B3, B4 bits of the single-chip microcomputer's status register; and
checking whether the corrupted BIOS is completely burned.

5. The method as described in claim 1, wherein the BIOS burning card has a mother BIOS for providing information written to the corrupted BIOS.

6. The method as described in claim 1, further comprising a step of verifying the mother BIOS before the BIOS burning card receives a burning instruction from the burning device to start burning.

7. The method as described in claim 1, wherein the burning device is a personal computer, and the BIOS burning card is connected with the burning device through serial ports.

8. The method as described in claim 1, wherein the BIOS burning card is connected with the corrupted motherboard by several probes.

9. The method as described in claim 1, wherein the burning device scans a barcode of the corrupted motherboard after the corrupted motherboard is received in the burning device.

10. The method as described in claim 9, wherein a soft control server receives the barcode of the corrupted motherboard and a burning result from the burning device.

11. A method for programming a programmable chip, comprising the steps of:
electrically connecting a programming device with a programmable chip;
identifying said programmable chip;
retrieving related information and user's instructions through said programming device;
programming said related information into said programmable chip based on said user's instructions; and
verifying said programmed information according a status recording of said programming device.

12. The method as described in claim 11, wherein said programmable chip is a memory chip on an identifiable motherboard to have a Basic Input Output System (BIOS) residing therein, said programming device is a BIOS burning card with a controllable single-chip microcomputer thereof so as to program said chip by means of a chip-burning process.

13. The method as described in claim 11, wherein said status recording of said programming device resides in a status register of said programming device.

14. A system for burning BIOS to a corrupted BIOS, the system comprising:
a corrupted motherboard with a corrupted BIOS attached;
a BIOS burning card connecting with the corrupted motherboard for burning the corrupted BIOS;
a burning device connecting with the BIOS burning card to control the BIOS burning card; and
a soft control server connecting with the burning device for receiving a burning result from the burning device.

15. The system as described in claim 14, wherein the BIOS burning card is connected with the corrupted motherboard by several probes.

16. The system as described in claim 14, wherein the BIOS burning card and the burning device are connected with each other by serial ports.

17. The system as described in claim 14, wherein the burning device is connected with the soft control server through network.

18. The system as described in claim 14, wherein the BIOS burning card comprises a single-chip microcomputer.

19. The system as described in claim 14, wherein the burning device scans a barcode of the corrupted motherboard, and sends it to the soft control server.

20. The system as described in claim 14, wherein the BIOS burning card has a mother BIOS providing information written to the corrupted BIOS.
